(19) United States
(12) Patent Application Publication
(10) Pub. No.: US 2025/0091900 A1
(43) Pub. Date: Mar. 20, 2025

(54) ALKALI METAL METALATE COMPOUNDS WITH MAGNETIC EXCHANGE BIAS AND IONIC CONDUCTIVITY PROPERTIES

(71) Applicant: FREIE UNIVERSITÄT BERLIN, Berlin (DE)

(72) Inventors: Günther THIELE, Berlin (DE); Mohammad Reza GHAZANFARI, Berlin (DE)

(73) Assignee: FREIE UNIVERSITÄT BERLIN, Berlin (DE)

(21) Appl. No.: 18/728,054

(22) PCT Filed: Jan. 10, 2023
(86) PCT No.: PCT/EP2023/050466

§ 371 Date: Jul. 10, 2024

(30) Foreign Application Priority Data
Jan. 10, 2022 (EP) 22150725.4

(51) Int. Cl. C01G 49/00; C01B 19/00; C01G 9/00; C01G 37/00; C01G 51/00; C01G 53/00; H01M 6/18; H01M 10/054; H01M 10/0562

(52) U.S. Cl. CPC C01G 49/009; C01B 19/002; C01G 9/006; C01G 37/006; C01G 51/82; C01G 53/82; H01M 6/18; H01M 10/054; H01M 10/0562; C01P 2002/77; C01P 2006/40; C01P 2006/42; H01M 2300/0068

(57) ABSTRACT

Please cancel the abstract of this application and replace it with the following amended abstract presented in clean form according to the procedures outlines in MPEP 714(II)(B): It is provided an alkali metal metalate compound with high magnetic exchange bias and ionic conductivity properties having the general formulae (I) A₂[M¹₃₋ₓ M²ₓ Z₄] with A being one of Li, Na, K; M¹, M² being one or more of Cr, Mn, Fe, Co, Ni, Cu, Zn; Z being S or Se; x being 0-3, preferably 0, 0.01, 0.1, 0.5, 1, 1.5, 2, 3; whereby the compounds K₂[Ni₃S₄], K₂[Zn₃S₄], K₂[Mn₃S₄], Na₂[Mn₃Se₄] and K₂[Ni₃Se₄] are exempted.

### CROSS-REFERENCE TO A RELATED APPLICATION

This application is the United States national phase of International Patent Application No. PCT/EP2023/050466, filed on Jan. 10, 2023, an claims priority of European Patent Application No. 22 150 725.4, filed on Jan. 10, 2022, the disclosure of which are hereby incorporated by reference in their entireties.

The disclosure relates to alkali metal metalate compounds with magnetic exchange bias and ionic conductivity properties and a method for obtaining said compounds.

### BACKGROUND

The continuous increase in spin-electronic technology demands is nowadays approached by a multitude of quantum materials as an inter-disciplinary research line of chemistry, physics, and materials engineering. Numerous scientific efforts have been focused on designing new materials with the desired electronic and magnetic features by tuning the chemical composition, structural parameters, and physical modifications.

Spin-electronic technologies are increasingly highlighted in a wide range of daily applications. Thus, designing the new quantum materials plays a key role in providing the controlled electronic and magnetic features corresponding to the desirable applications. Regarding providing both magnetic exchange bias and ionic conductivity for proposed materials in this proposal, State of Technology could be divided in two parts: (1) Exchange bias effects and (2) Ionic conductivity.
(1) Magnetic exchange bias effect was firstly discovered around 50 years ago, and lots of research works have been carried out on that. Exchange bias could extensively be employed for designing data storage devices like magnetoresistive random-access memory MRAM and spintronic applications [F. Radu, H Zabel, Exchange Bias Effect of Ferro-/Antiferromagnetic Heterostructures. In: Zabel H., Bader S. D. (eds) Magnetic Heterostructures. Springer Tracts in Modern Physics, 2008, vol 227. Springer, Berlin, Heidelberg]. Conventionally, magnetic exchange bias is obtained from a combination of two different phases with ferromagnetic and antiferromagnetic structures, in most cases in a sandwich combination like two layers of thin films, which could magnetically interact together and pin the moments according to the direction of the applied magnetic field. The most common materials for exchange bias behaviors in technological applications are the combinations of ferromagnetic alloys and antiferromagnetic oxides such as Ni/NiO [A. Kremenovic et al., J. Phys. Chem. C 2012, 116, 7, 4356-4364.2], Co/CoO [A. K. Suszka et al., Phys. Rev. Lett. 2012, 109, 17, 177205-177209], Fe/NiO [E. Mlynczaket al., J. App. Phys. 2013, 113, 234315], NiFe/NiO [Y. J. Zhang et al., J. App. Phys. 2009, 105, 083910], etc. However, in almost all of them the design and fabrication of homogenous combinations of two phases are challenging. In addition, several new combined structures including composites [J. A. Gonzalez et al., Chem. Mater. 2017, 29, 12, 5200-5206] and core-shell nanoparticles [E. A. Velasquez et al., Adv. Mater. Interfaces 2020, 7, 17, 2000862] are designed to overcome the challenges. In recent years, a few exchange bias materials consisting of single chemical phases have been introduced including ferromagnetic, ferrimagnetic, antiferromagnetic, and spin glass orderings, but some drawbacks such as low exchange bias field, sparse and/or toxic elemental combinations, and expensive and complicated synthesis procedures still persist [Y. Sun et al., Appl. Phys. Lett. 2013, 102, 172406]. Therefore, the materials consisting of nontoxic abundant elements with a straightforward synthesis process and indicating a large exchange bias are still missing.
(2) Although currently most of the required energy for societal demands comes from the environment-unfriendly resources of fossil fuels, the modern world is changing rapidly to develop clean energy technologies. Alkali metal-ion batteries especially Li-, N-, and K-ion batteries are the flagship of modern energy storage devices. These cells commonly contain solid electrodes and liquid electrolytes. Although alkali metal-ion batteries are the most efficient electrochemical energy storage device, they are faced with several challenges in their electrolyte parts such as safety issues related to the flammability, leakage of the liquid electrolytes, undesired reactions between electrodes and electrolytes, complicated connections between the components and assembling of the cells [M. Zhou et al., Adv. Mater. 2021, 33, 7, 2003741]. Solid state electrolytes attract many considerations as the safest candidates instead of commercial liquid electrolytes. Furthermore, by using solid state electrolytes, the assembling procedures of the battery cells have less costs and difficulties [Y. Liu et al., Small 2020, 16, 44, 2004096]. Recently, several solid-state electrolytes have been introduced to prevail over the mentioned drawbacks. Ionic conductivity is a key step to develop the solid-state electrolyte and necessarily should be high enough at ambient temperature for providing efficient alkali metal-ion batteries [H. Yuan et al., J. Mater. Chem. A 2018, 6, 8413-8418]. Despite the numerous works on this topic, almost all of them indicate relatively low ionic conductivity values in the range of 10⁻⁸ to 10⁻⁴ Scm⁻¹ that is not comparable with the commercial liquid electrolytes.

### SUMMARY

Thus, it was an object underlying the proposed solution to provide a class of compounds that combines a large exchange bias and a high ionic conductivity.

This object has been solved by providing a compound with the features as described herein.

Accordingly, alkali metal metalate compounds with magnetic exchange bias and ionic conductivity properties is provided, wherein the alkali metalate compounds has the general formulae (I)

$${A}_{2} [ {{M}^{1}}_{3 - x} {{M}^{2}}_{x} {Z}_{4} ] \qquad ( I )$$

with
A being one of Li, Na, K,
M¹, M² being one or more of Cr, Mn, Fe, Co, Ni, Cu, Zn,
Z being S or Se,
x being in the range of 0-3, preferably 0, 0.01, 0.1, 0.5, 1, 1.5, 2, 3, whereby the compounds K₂[Ni₃S₄], K₂[Zn₃S₄], K₂[Mn₃S₄], Na₂[Mn₃Se₄] and K₂[Ni₃Se₄] are exempted. In an embodiment, Na₂[Zn₃S₄] may also be exempted.

In an embodiment, the compound has the general formulae (II)

$${A}_{2} [ {{M}^{1}}_{3 - x} {{M}^{2}}_{x} {Z}_{4} ] \qquad ( II )$$

with
A being Na or K,
M¹ being Fe;
M² being one of Cr, Mn, Co, Ni, Cu, Zn,
Z being S or Se,
x being in the range of 0-3, preferably 0, 0.01, 0.1, 0.5, 1, 1.5, 2, 3.

In a further embodiment the compound is of general formulae (Ill)

$${A}_{2} [ {Fe}_{3 - x} {{M}^{2}}_{x} {Z}_{4} ] \qquad ( III )$$

with
A being K or Na,
M² being one of Cr, Mn, Co, Ni, Cu, Zn,
Z being S or Se,
x being 0, 0.5, 1, 1.5, 2, 3.

In still another embodiment, the present compound is one of the following:
A₂[Fe₃S₄];
A₂[Fe₂CoS₄]; A₂[Fe_{1.5}CO_{1.5}S₄]; A₂[FeCo₂S₄]; A₂[Co₃S₄];
A₂[Fe₂NiS₄]; A₂[Fe_{1.5}Ni_{1.5}S₄]; A₂[FeNi₂S₄]; A₂[Ni₃S₄];
A₂[Fe₂CuS₄]; A₂[Fe_{1.5}Cu_{1.5}S₄]; A₂[FeCu₂S₄]; A₂[Cu₃S₄];
A₂[Fe₂ZnS₄]; A₂[Fe_{1.5}Zn_{1.5}S₄]; A₂[FeZn₂S₄]; A₂[Zn₃S₄];
A₂[Fe₂MnS₄]; A₂[Fe_{1.5}Mn_{1.5}S₄]; A₂[FeMn₂S₄]; A₂[Mn₃S₄];
A₂[Fe₂CrS₄]; A₂[Fe_{1.5}Cr_{1.5}S₄]; A₂[FeCr₂S₄]; A₂[Cr₃S₄];
A₂[Fe₃Se₄];
with A being Na or K.

In yet a further embodiment the present compound is one of the following:
K₂[Fe₃S₄]; Na₂[Fe₃S₄];
K₂[Fe₂CoS₄]; K₂[Fe_{1.5}Co_{1.5}S₄];
K₂[Co₃S₄];
K₂[Cr₃S₄];
K₂[Fe₃Se₄].

In an embodiment, the present compound has an ionic conductivity in a range between 1×10⁻¹ and 1×10⁻³ Scm⁻¹, preferably in a range between 1×10⁻² and 1×10⁻³ Scm⁻¹, more preferably between 2×10⁻² and 8×10⁻² Scm⁻¹. Thus, the present compounds can be used as a solid-state electrolyte and as an electrode in all alkali metal batteries.

In a further embodiment, the present compound has an exchange bias field in a range between 20 and 50 mT, preferably between 30 and 40 mT, more preferably between 33 and 38 mT at 3K. The ionic conductivity and exchange bias can be tuned by freely varying the amount of individual metal ions.

Depending on the size of individual ions, or the ratio of ionic radii in mixed metal compounds, the symmetry of the structure is reduced, for example K₂[Cr₃S₄] crystallizes in monoclinic space group C2/m with full occupation of chromium atoms; K₂[Fe₃S₄] crystallizes in 14/mmm space group and Na₂[Fe₃S₄] crystallizes in P-3m1 space group.

Further derivatives to additionally tailor the ionic conductivity and exchange bias can be obtained by incorporating three and more metal ions within the structural framework. Table 1 shows a list of compounds to represent the variety of the solid solution behavior of A₂[M¹₃₋ₓM²ₓS₄] with M¹=Fe.

TABLE 1

| 3d | Chemical composition of A₂[Fe₃₋ₓMₓS₄], A = | | | | |
|---|---|---|---|---|---|
| transition | Li, Na, K and M = Cr, Mn, Fe, Co, Ni, Cu, Zn | | | | |
| metal | 0 | 1 | 1.5 | 2 | 3 |
| Fe—Co | K₂[Fe₃S₄], | A₂[Fe₂CoS₄] | A₂[Fe_{1.5}Co_{1.5}S₄] | A₂[FeCo₂S₄] | A₂[Co₃S₄] |
| Fe—Ni | Na₂[Fe₃S₄] | A₂[Fe₂NiS₄] | A₂[Fe_{1.5}Ni_{1.5}S₄] | A₂[FeNi₂S₄] | A₂[Ni₃S₄] |
| Fe—Cu | Li₂[Fe₃S₄] | A₂[Fe₂CuS₄] | A₂[Fe_{1.5}Cu_{1.5}S₄] | A₂[FeCu₂S₄] | A₂[Cu₃S₄] |
| Fe—Zn | | A₂[Fe₂ZnS₄] | A₂[Fe_{1.5}Zn_{1.5}S₄] | A₂[FeZn₂S₄] | A₂[Zn₃S₄] |
| Fe—Mn | | A₂[Fe₂MnS₄] | A₂[Fe_{1.5}Mn_{1.5}S₄] | A₂[FeMn₂S₄] | A₂[Mn₃S₄] |
| Fe—Cr | | A₂[Fe₂CrS₄] | A₂[Fe_{1.5}Cr_{1.5}S₄] | A₂[FeCr₂S₄] | A₂[Cr₃S₄] |

The proposed solution introduces new alkali metal metalate compounds as potential partially non-toxic, abundant element-based variant of the AFe₂Se₂ structure type. Regarding the significant dependency of electronic and magnetic properties of materials to their chemical composition and crystal structure, these new compounds indicate the remarkable magnetic and electronic properties.

Even though a few sulfides of the above type, such as K₂[Ni₃S₄], K₂[Zn₃S₄], K₂[Mn₃S₄], Na₂[Mn₃Se₄] and K₂[Ni₃Se₄] or Cs₂Mn₃O₄ and Cs₂Co₃O₄ (Bronger et al., Z. anorgan. Allg. Chem, 1988, 559:95-15 referenced by Ying-Jie Lu et al., Comments Inorg. Chem. 1993, 14:229-243) have been described, the presently claimed compounds have excellent electronic and magnetic properties that have not been described so far.

As mentioned above, K₂[Fe₃S₄], Na₂[Fe₃S₄], K₂[Fe₃Se₄] and K₂[Co₃S₄] are preferred embodiments.

K₂[Fe₃S₄] crystallizes in /4/mmm space group with two units in the unit cell with a=3.7730(2) Å, c=13.3526(9) Å, V=190.08(2) Å³. The iron atoms are tetrahedrally coordinated by sulfur atoms with Fe—S bond lengths of 2.344 Å. [Fe^{II}S₄]⁶⁻ tetrahedra are edge-sharing to form anionic layers. The iron positions are statistically occupied at 75%, which was confirmed by single crystal X-ray diffraction and energy-dispersive X-ray spectroscopy measurements. K₂[Fe₃S₄] is the first potassium sulfidoferrate compound with the pure Fe (II), as well as layered anionic sublattice.

Na₂[Fe₃S₄] crystallizes in P-3m1 space group with one unit in the unit cell with a=3.8495(3) Å, c=6.7606(5) Å, V=86.761(15) Å3. The iron atoms are tetrahedrally coordinated by sulfur atoms. [Fe^{II}S₄]⁶⁻ tetrahedra are edge-sharing to form anionic layers with two perpendicular conductivity channels for Na ions in parallel and perpendicular to the ab plane. The iron positions are statistically occupied at 75%, which was also confirmed by single crystal X-ray diffraction measurements.

These compounds can provide large exchange bias fields and outstanding ionic conductivity at the same time. According to the magnetic measurements, K₂[Fe₃S₄] has both antiferromagnetic and spin glass orderings, which lead to introduce the large exchange bias field of around 35, 27, and 7 mT at 3, 20, and 100 K. Thus, K₂[Fe₃S₄] can be considered as a decent candidate for exchange bias applications, particularly at low temperatures.

On the other hand, K₂[Fe₃S₄] demonstrates very high ionic conductivity while in other materials the low ionic conductivity is the main drawback of the solid state electrolytes in all solid state batteries. According to the complex impedance measurements, K₂[Fe₃S₄] shows an outstanding ionic conductivity of 2.16×10⁻² Scm⁻¹ that is much higher than usual solid state electrodes and is comparable with the common liquid electrolytes. This is in the range of the highest value reported for the ionic conductivity of the potential solid-state electrolyte in the K-ion battery applications.

Na₂[Fe₃S₄] with a layered anionic sublattice and 25% statistical iron vacancies result in a bulk ionic conductivity of 3.37 ms·cm⁻¹ at room temperature upon appropriate sintering. This value is in the range of the highest reported values for sodium-based compounds. Further optical investigations indicate the semiconductivity of Na₂[Fe₃S₄] with a band gap of 1.69 eV. Magnetometry results illustrate an antiferromagnetic structure with a Néel temperature of 120 K. Therefore, Na₂[Fe₃S₄] is a multifunctional, superionic conductor material with a sustainable elemental combination and potential for application in sodium-based electrochemical cells.

K₂[Co₃S₄], as the first layered potassium sulfido cobaltate, has a network structure with the layered anionic sublattices including the 25% of cobalt vacancies. The sintered samples of compound indicate a high dielectric constant of 2650 at 1 kHz, comparable with the benchmark dielectric materials, as well as an outstanding ionic conductivity value of around 21.3 ms·cm⁻¹, in the range of highest ever reported values for potassium-containing compounds. In addition, the magnetometry results demonstrate a giant exchange bias field of around 430 mT, originated by the combination of antiferromagnetic and spin glass phases.

K₂[Fe₃Se₄], has 25% statistical vacancy of iron ions. Magnetic measurements reveal the antiferromagnetic ordering of the compound as well as large exchange bias fields of 0.22 and 0.13 T at the temperatures of 2 and 20 K, respectively. The complex impedance investigations indicate a very high ionic conductivity of around 31.04 ms·cm⁻¹ at ambient temperature, which is the highest reported value for potassium-containing materials in large-scale. In addition, dielectric measurements illustrate a high dielectric constant of 2029 at 1 kHz, in the range of benchmark materials

The present compounds are obtainable in a method that comprises the step of reacting A₂Z with equivalents of M¹Z and M²Z at a temperature between 1073 K and 1473 K, preferably between 1123 K and 1373 K, more preferably between 1173 K and 1273 K, under inert gas atmosphere for 5-30 min, preferably 10-20 min. Thus, the synthesis of the present compounds is straightforward.

In an embodiment of the present method A₂Z is obtained from reacting elemental A and elemental Z in liquid NH₃ under inert gas atmosphere.

For example, to synthesize the present compounds, the reaction of K₂S with two equivalents of FeS in a quartz ampoule at around 1273 K yields after 15 minutes reaction time phase pure K₂[Fe₃S₄] without any further purification. Reactions and all preparation steps are done under inert atmosphere.

As indicated above, the present compounds are applicable for exchange bias applications, in particular in transistors, MOSFETs, MRAMs, or as solid-state electrolytes, in particular in solid-state batteries.

### BRIEF DESCRIPTION OF THE DRAWINGS

The solution is explained in the following by means of the examples with reference to the figures.

FIG. 1a shows depiction of the crystal structure of K₂[Fe₃S₄].

FIG. 1b shows temperature dependent magnetization curves of. K₂[Fe₃S₄].

FIG. 1c shows magnetization curves after cooling under applied field of 3 T of K₂[Fe₃S₄].

FIG. 1d shows dielectric and complex impedance properties of K₂[Fe₃S₄].

FIG. 2a shows depiction of the crystal structure of Na₂[Fe₃S₄].

FIG. 2b shows dielectric and complex impedance properties of Na₂[Fe₃S₄].

FIG. 2c shows magnetization curves of Na₂[Fe₃S₄].

FIG. 3a shows depiction of the crystal structure of K₂[Co₃S₄].

FIG. 3b shows magnetization curves of K₂[Co₃S₄].

FIG. 3c shows dielectric and complex impedance properties of K₂[Co₃S₄].

FIG. 4a shows depiction of the crystal structure of K₂[Fe₃Se₄].

FIG. 4b shows magnetization curves of K₂[Fe₃Se₄].

FIG. 4c shows dielectric and complex impedance properties of K₂[Fe₃Se₄].

FIG. 5a shows depiction of the crystal structure of K₂[(Fe/Co)₃Se₄].

FIG. 5b shows magnetization curves of K₂[(Fe/Co)₃Se₄].

FIG. 5c shows complex impedance properties of K₂[(Fe/Co)₃Se₄].

FIG. 6 shows depiction of the crystal structure of K₂[Cr₃S₄].

### DETAILED DESCRIPTION

### Example 1: Synthetic Details

All proposed alkali metal sulfido metalate compounds with the stoichiometry ratio of A₂[M¹₃₋ₓM²ₓS₄] have been synthesized through the solid state reactions, by mixing the starting materials and subsequent heat treatment. Regarding the air- and moisture-sensitivity of the compound and most of the starting materials, all steps of the synthesis processes were performed under inert atmosphere conditions using Ar-filled glovebox and/or Schlenk lines. The purity of all products was investigated and confirmed by the results of X-ray diffraction and Energy-dispersive X-ray spectroscopy measurements. The description of the synthetic details for each compound are listed in table 2. More details about the synthesis processes are provided in following parts.

TABLE 2

| | Starting | Reaction | Reaction | Color of | Yield |
|---|---|---|---|---|---|
| Compound | materials | temperature | time | product | per run |
| K₂[Fe₃S₄] | K₂S + 3 FeS | ≈1173 K | ≈10 min | Dark green | ≈20 g |
| Na₂[Fe₃S₄] | Na₂S + 3 FeS | ≈1123 K | ≈6 min | Dark green | ≈18 g |
| K₂[Co₃S₄] | K₂S + 3 CoS | ≈1173 K | ≈10 min | Dark gray | ≈20 g |
| K₂[Ni₃S₄] | K₂S + 3 Ni + 3 S | ≈1173 K | ≈10 min | Golden | ≈20 g |
| K₂[Cr₃S₄] | K₂S + 3 Cr + 3 S | ≈1273 K | ≈15 min | Gray | ≈15 g |
| K₂[Zn₃S₄] | K₂S + 3 ZnS | ≈1173 K | ≈10 min | Brown | ≈20 g |
| K₂[Fe₃₋ₓCoₓS₄] | K₂S + (1.5)₁₋ₓ | ≈1173 K | ≈10 min | Dark gray | ≈20 g |
| | FeS + (1.5)ₓ CoS | | | | |

### Starting Materials

FeS, CoS, ZnS, Ni, Cr, Se and S are purchased in commercial grades and purity of all of them have been evaluated and confirmed before using.

Synthesis K₂S (applicable method for K₂Se, using selenium instead of sulfur with adjusted masses): 20 g (2 eq, 0.5115 mol) K (ACROS organics, 98%) were placed in three necks flask connected to NH₃ gas flow. Using the cooling bath of ethanol and dry ice, the temperature of the flask was decreased to around 198 K to condense NH₃ from the gas phase to liquid form. Since the reaction of elemental potassium and sulfur could be very exothermic, potassium chucks were initially dissolved in the liquid NH₃ under inert atmosphere up to a change of the color of the stirring solution to dark blue. Afterwards, 8.2 g (1 eq, 0.2557 mol) S (abcr, 99% sublimed) was gradually added to the solution at the temperature of around 240 K. The mixture was stirred overnight to complete the reaction and slowly release NH₃ by allowing the temperature to increase to room temperature. Inside the glovebox, the powder was grinded and prepared for powder X-ray diffraction analysis to verify the purity.

Synthesis Na₂S: 17.68 g (2 eq, 0.7693 mol) Na (ACROS organics, 98%) were placed in three necks flask connected to NH₃ gas flow. Using the cooling bath of ethanol and dry ice, the temperature of the flask was decreased to around 197 K to condense NH₃ from the gas phase to liquid form. Since the reaction of elemental sodium and sulfur could be very exothermic, sodium chucks were initially dissolved in the liquid NH₃ under an inert atmosphere up to a change of the color of the stirring solution to dark blue. Afterwards, 12.32 g (1 eq, 0.3842 mol) S (abcr, 99% sublimed) was gradually added to the solution at the temperature of around 240 K. The mixture was stirred overnight to complete the reaction and slowly release NH₃ by allowing the temperature to increase to room temperature. Inside the glovebox, the powder was grinded and prepared for powder X-ray diffraction analysis to verify the purity.

### Ternary Compounds

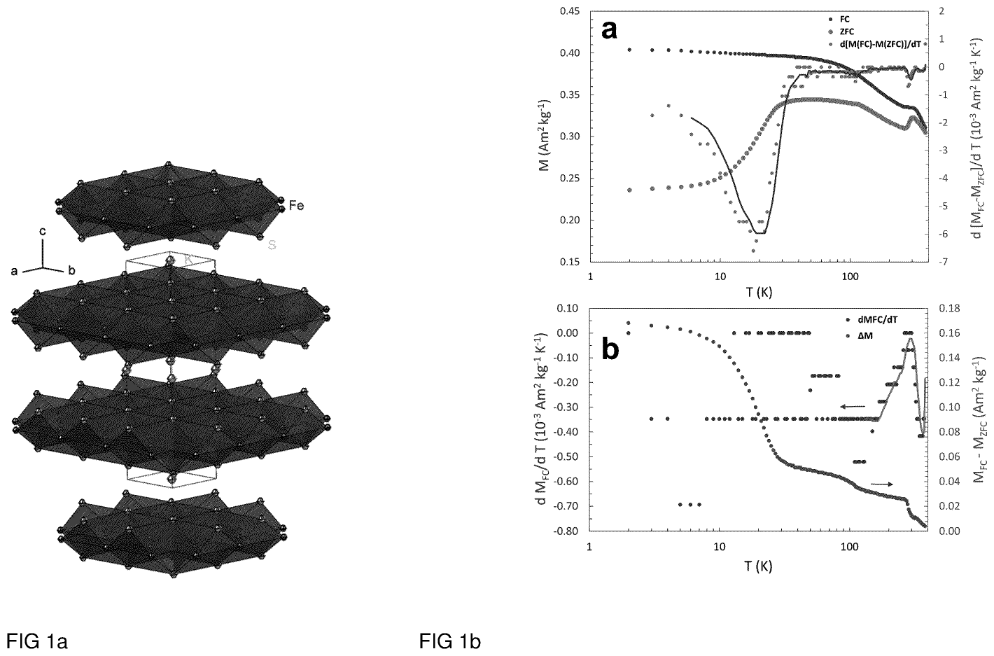

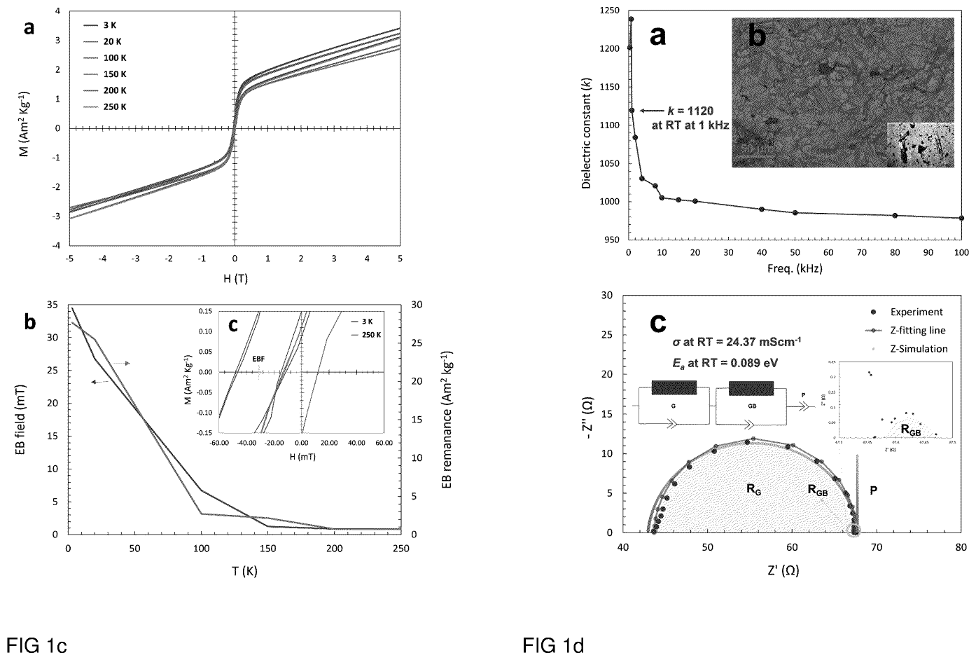

Synthesis of K₂[Fe₃S₄]: 10 g (1 eq, 0.091 mol) of synthesized K₂S and 23.91 g (3 eq, 0.272 mol) FeS (Sigma-Aldrich) were homogenously mixed and placed in a quartz ampoule. The ampoule was connected to a Schlenk line with pressure release option and heated to approx. 1173 K (orange glowing of the ampule) for about 10 minutes under Ar flow and allowed to cool to room temperature. After cooling down, the ampule was transferred into the glovebox, carefully broken, and compound blocks were removed. Multigram of pure product was obtained as dark green, air and moisture sensitive powder. The structure for this compound is depicted in FIG. 1a.

K₂[Fe₃S₄] crystallizes in 14/mmm space group with two units in the unit cell with a=3.7730(2) Å, c=13.3526(9) Å, V=190.08(2) Å³. The iron atoms are tetrahedrally coordinated by sulfur atoms with Fe—S bond lengths of 2.344(8) Å. [Fe^{II}S₄]⁶⁻ tetrahedra are edge-sharing to form anionic layers. The iron positions statistically occupied at 75%, which was also confirmed by the X-ray diffraction and energy-dispersive X-ray spectroscopy measurements. K₂[Fe₃S₄] is the first potassium sulfidoferrate compound with pure Fe (II) and a layered anionic sublattice.

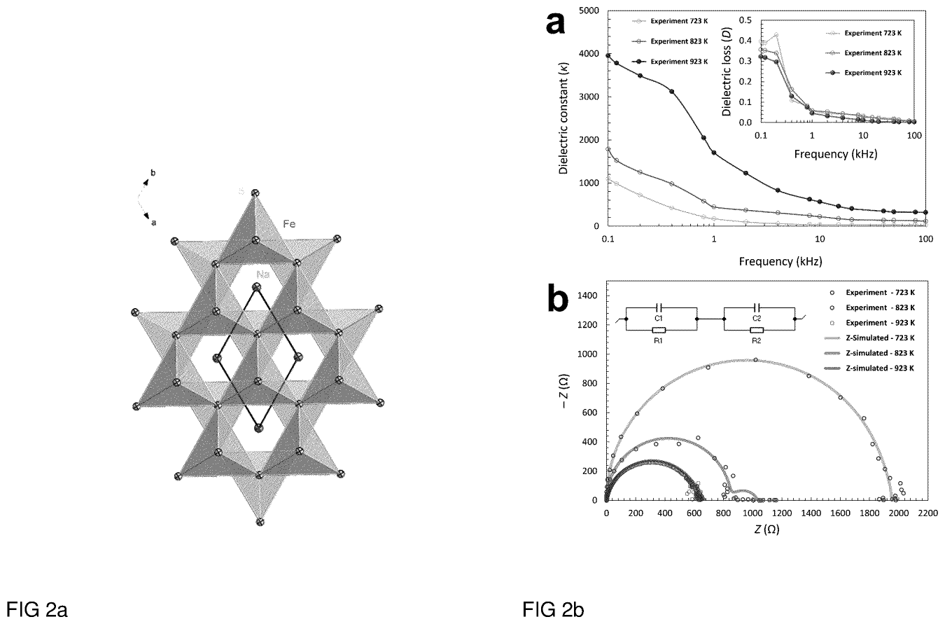

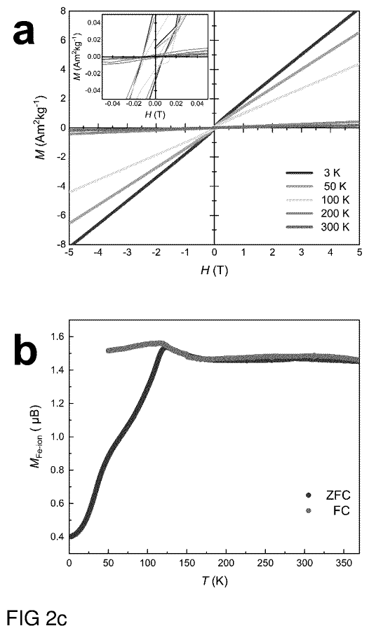

Synthesis of Na₂[Fe₃S₄]: 10 g (1 eq, 0.128 mol) of synthesized Na₂S and 33.79 g (3 eq, 0.384 mol) FeS (Sigma-Aldrich) were homogenously mixed and placed in a quartz ampoule. The ampoule was connected to a Schlenk line with pressure release option and heated to approx. 1123 K for about 6 minutes under Ar flow and allowed to cool to room temperature. After cooling down, the ampule was transferred into the glovebox, carefully broken, and compound blocks were removed. Multigram of pure product was obtained as dark green, air and moisture sensitive powder. The structure for this compound is depicted in FIG. 2a.

Na₂[Fe₃S₄] crystallizes in P-3m1 space group with one unit in the unit cell with a=3.8495(3) Å, c=6.7606(5) Å, V=86.761(15) Å³. The iron atoms are tetrahedrally coordinated by sulfur atoms. [Fe^{II}S₄]⁶⁻ tetrahedra are edge-sharing to form anionic layers with two perpendicular conductivity channels for Na ions in parallel and perpendicular to the ab plane. The iron positions statistically occupied at 75%, which was also confirmed by the X-ray diffraction measurements.

Synthesis of K₂[Co₃S₄]: 10 g (1 eq, 0.091 mol) of synthesized K₂S and 24.75 g (3 eq, 0.272 mol) CoS (Sigma-Aldrich) were homogenously mixed and placed in a quartz ampoule. The ampoule was connected to a Schlenk line with pressure release option and heated to approx. 1173 K (orange glowing of the ampule) for about 10 minutes under Ar flow and allowed to cool to room temperature. After cooling down, the ampule was transferred into the glovebox, carefully broken, and compound blocks were removed. Multigram of pure compound was obtained as dark gray, air and moisture sensitive powder. The structure for this compound is like the structure of K₂[Fe₃S₄] as an isotypic structure.

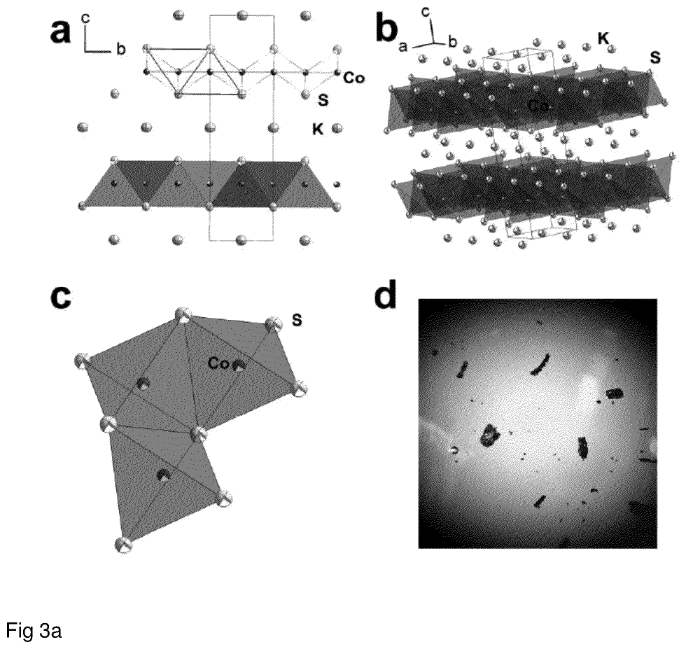

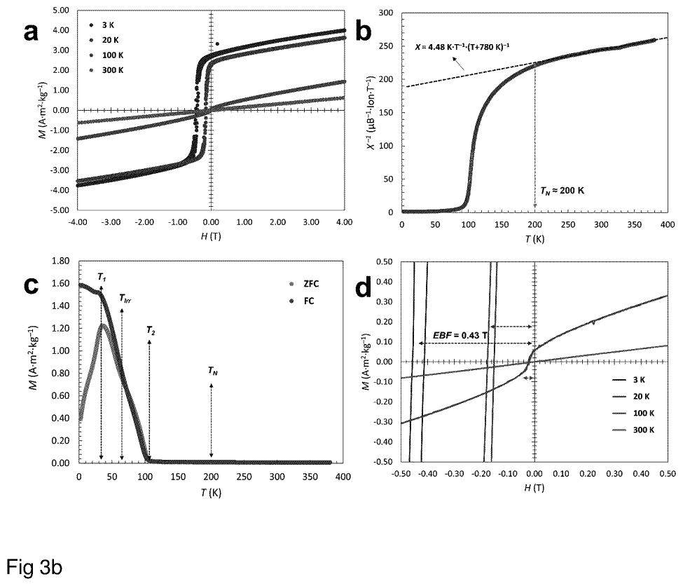

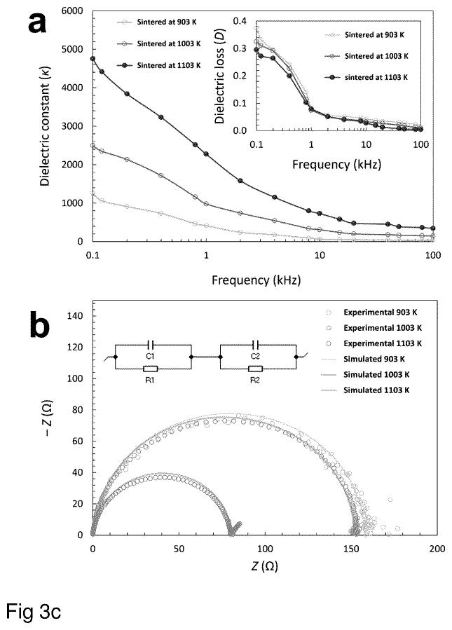

The crystal structure of K₂[Co₃S₄] is depicted in FIG. 3a: (a) Depicted along a including edge-sharing [CoS₄]⁶⁻-tetrahedra. (b) 2D anionic substructure of [Co₃S₄]²⁻ as layers in the ab plane (c) Edge-sharing tetrahedra connections to create anionic layers (d) Light microscopy photograph of single crystals of K₂[Co₃S₄] at 60× magnification. Selected bond lengths and angles: Co—S: 2.3054(31) Å, K—S: 3.3163(33) Å, S—Co—S: 109.066(31)-109.674(12)°. Partial occupations of cobalt atoms are omitted for clarity.

Synthesis of K₂[Fe₃Se₄]: K₂Se, Fe, and Se were mixed together in stoichiometric ratios. The preparation was performed under inert conditions. The precursor K₂Se was synthesized by using K (14.82 g, 379.04 mmol, 2 eq.) dissolved in an NH₃ solution. After that, Se (15.07 g, 189.97 mmol, 1 eq.) was added to the stirred solution. After passing through, the color change from dark blue to gray and then turns beige after stirring overnight. The solid was dried under a vacuum. The PXRD confirmed K₂Se without impurities. After that, K₂Se (2.80 g, 17.82 mmol, 1 eq.), Fe (2.98 g, 53.45 mmol, 3 eq.), and Se (4.22 g, 53.45 mmol, 3 eq.) were transferred to a fused silica ampule. With a methane-oxygen torch around 1250 K for 10 minutes, all starting materials were reacted under argon. The cooled ampule was transferred to an Ar-filled glovebox. K₂[Fe₃Se₄] was obtained as a black metallic powder.

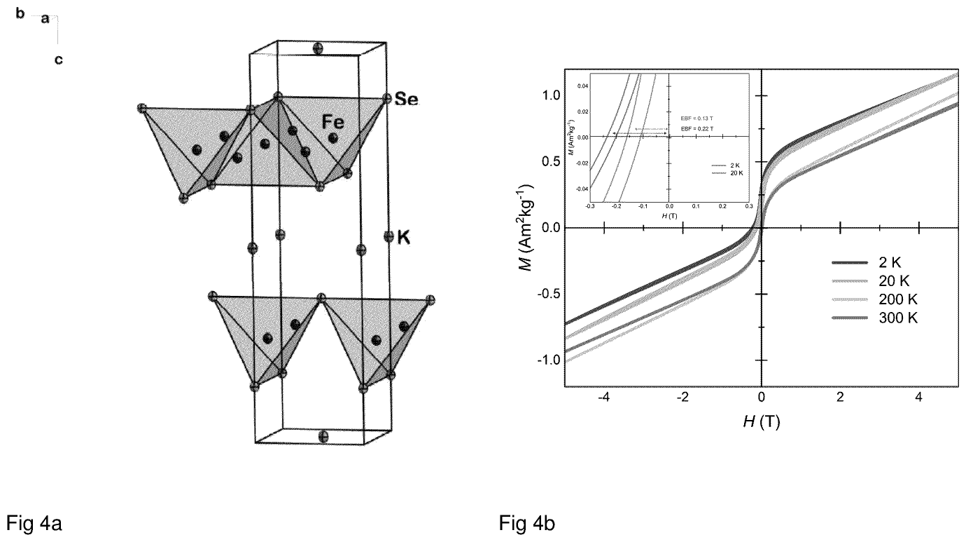

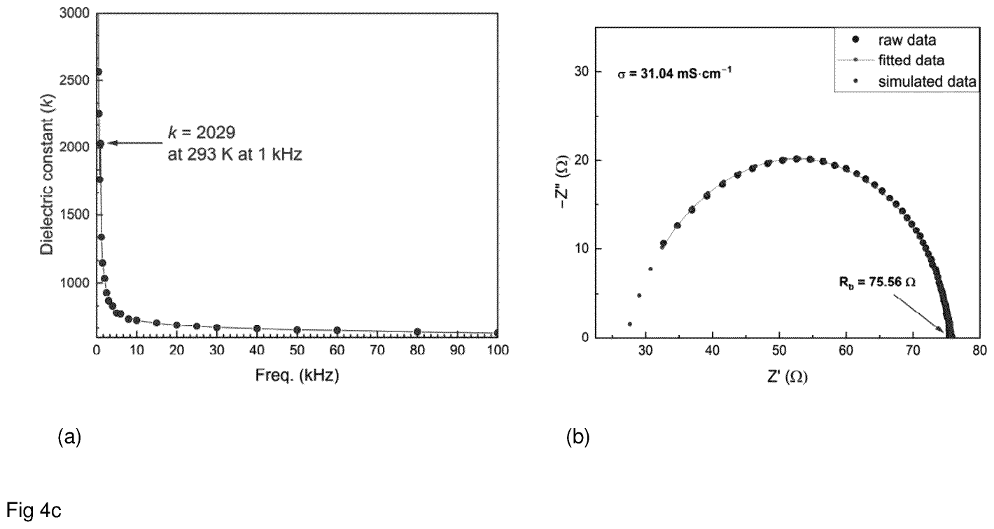

K₂[Fe₃Se₄] crystallizes in the tetragonal space group 14/mmm (no. 139) with two independent units per unit cell. Each iron atom is tetrahedrally surrounded by four selenium atoms; potassium atoms serve as counter ions. FIG. 4a indicates the crystal structure, showing a statistical occupation on the iron atom position of 75%. The figure shows the crystal structure along the ac-plane, information about distances and atom positions are listed in the electronic supporting information.

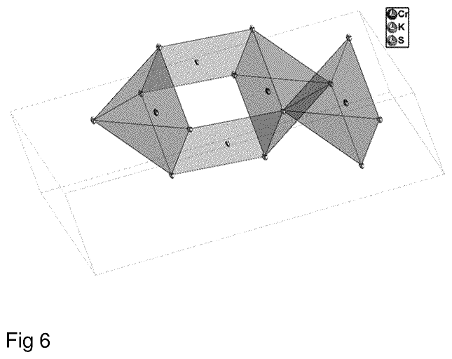

Synthesis of K₂[Cr₃S₄]: 10.54 g (1 eq.) of synthesized K₂S and 8.72 g (3 eq.) S were homogenously mixed and placed in a quartz ampoule. 14.14 g (3 eq.) elemental chromium were placed in a Schlenk flask and connected to the quartz ampoule. The ampoule was connected to a Schlenk line with pressure release option and heated to approx. 773 K to melt the mixture of K₂S and sulfur and then gradually added the elemental chromium to the molten phase and heated it to approx. 1273 K (yellow glowing of the ampule) for about 15 minutes under Ar flow and allowed to cool to room temperature. After cooling down, the ampule was transferred into the glovebox, carefully broken, and compound blocks were removed. Multigram of pure compound was obtained as gray, air and moisture sensitive powder. The obtain structure crystallizes in C2/m space group with two units in the unit cell with a=13.503 (2) Å, b=3.6078 (4) Å, c=7.7210 (13) Å, α=90, β=105.701 (6), γ=90, V=362.10 (9) Å³. The chromium atoms are tetrahedrally coordinated by sulfur atoms. The structure for this compound is depicted in FIG. 6

Synthesis of K₂[Ni₃S₄]: 10 g (1 eq.) of synthesized K₂S and 8.72 g (3 eq.) S were homogenously mixed and placed in a quartz ampoule. 16 g (3 eq.) elemental nickel were placed in a Schlenk flask and connected to the quartz ampoule. The ampoule was connected to a Schlenk line with pressure release option and heated to approx. 773 K to melt the mixture of K₂S and sulfur and then gradually added the elemental chromium to the molten phase and heated it to approx. 1173 K (yellow glowing of the ampule) for about 10 minutes under Ar flow and allowed to cool to room temperature. After cooling down, the ampule was transferred into the glovebox, carefully broken, and compound blocks were removed. Multigram of pure compound was obtained as golden, air and moisture sensitive powder.

Synthesis of K₂[Zn₃S₄]: 10 g (1 eq, 0.091 mol) of synthesized K₂S and 26.51 g (3 eq, 0.272 mol) ZnS were homogenously mixed and placed in a quartz ampoule. The ampoule was connected to a Schlenk line with pressure release option and heated to approx. 1173 K (orange glowing of the ampule) for about 10 minutes under Ar flow and allowed to cool to room temperature. After cooling down, the ampule was transferred into the glovebox, carefully broken, and compound blocks were removed. Multigram of pure compound was obtained as dark gray, air and moisture sensitive powder. The obtain structure for this compound is like the structure of K₂[Fe₃S₄] as an isotypic structure.

### Quaternary Compounds

Synthesis of K₂[Fe₃₋ₓCoₓS₄] (x=0, 1, 2): For synthesizing these compounds, the stoichiometric rations of synthesized K₂S, FeS, and CoS were homogenously mixed and placed in a quartz ampoule. The ampoule was connected to a Schlenk line with pressure release option and heated to approx. 1173 K (orange glowing of the ampule) for about 10 minutes under Ar flow and allowed to cool to room temperature. After cooling down, the ampule was transferred into the glovebox, carefully broken, and compound blocks were removed. Multigram of pure product was obtained as dark green, air and moisture sensitive powder. The obtain structures for these compounds are like the structure of K₂[Fe₃S₄] and K₂[Co₃S₄] as the potential isotypic structures.

### Example 2: Analytics of K₂[Fe₃S₄]

### Exchange Bias Effects

Magnetic properties of K₂[Fe₃S₄] were evaluated based on the curves of magnetization as a function of the applied magnetic field at different temperatures and fields. To determine the magnetic structure of K₂[Fe₃S₄], the magnetization-field curves can be employed while their shape and trend identify the type of magnetic ordering. Field dependent magnetization plots of K₂[Fe₃S₄] at constant temperatures (not shown) indicate non-linear narrow hysteresis loops. The observed hysteresis loop at low fields is a sign of ferromagnetic (FM) ordering while the unsaturated linear part at high fields is a known characteristic of antiferromagnetic (AFM) structures. This combination indicates a complex magnetic structure in K₂[Fe₃S₄] consisting of a coexistence of both ordering types.

The temperature-dependent magnetization curves at constant fields and after cooling under zero applied field, which are denoted field cooled (FC) and zero field cooled (ZFC) curves respectively, provide more information about the magnetic ordering. FIG. 4a depicts the FC/ZFC curves of K₂[Fe₃S₄] in the temperature range of 1 to 380 K. The first obvious point in the figure is the separation of the FC and the ZFC curves over the whole temperature range and particularly at low temperatures. The separation of the curves indicates the existence of a spin-glass structure. Starting at low temperatures the difference of the magnetization values between the FC and the ZFC curves is increased up to around 20 K. At higher temperatures the difference dramatically decreased as a function of temperature. To clearly identify the characteristics of both AFM and spin-glass orderings the tendency of the variation can be followed by the first derivative of the magnetization difference, d[M_{FC}−M_{ZFC}]/dT. Accordingly, the minimum value of the d[M_{FC}−MZ_{FC}]/dT curve (FIG. 4a) shows the magnetic freezing temperature at around 20 K, that corresponds to the changing point of the slope in the ZFC curve.

At temperatures around 314 K there are small cusps in both, the FC and the ZFC curves which correspond to the Néel temperature of the AFM phase. Above the Néel temperature, the dominant magnetic structure is transformed from an AFM to a paramagnetic ordering. In addition, the ZFC invers susceptibility (X) curve indicates a significant deviation from the fitting line of the Curie-Weiss law at around 314 K (not shown), validating the Néel temperature determination of the AFM phase. The negligible change in the slope of FC curve at temperatures slightly below the freezing temperature can be considered as another confirmation of the spin-glass effects. To confirm the AFM ordering and Néel transition temperature, the magnetization variation of FC curve can be investigated as the derivation equation of dM_{FC}/dT. The maximum value of dM_{FC}/dT curve (FIG. 4b) demonstrates the same obtained Néel temperature of 314 K.

FIG. 4b indicates another characteristic temperature of the complex ordering, bifurcation temperature, which is defined as a starting point of FC/ZFC curves separation. The bifurcation temperature in K₂[Fe₃S₄], according to the difference variations of the FC/ZFC values, indicates the reversibility character of the magnetic behavior. The curve of ΔM=M_{FC}−M_{ZFC} as a function of the temperature determines that the irreversibility (bifurcation) temperature of the structure is higher than 380 K, which is the maximum available measurement range.

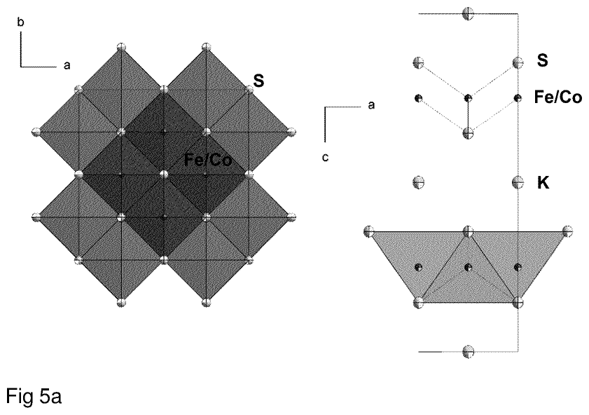

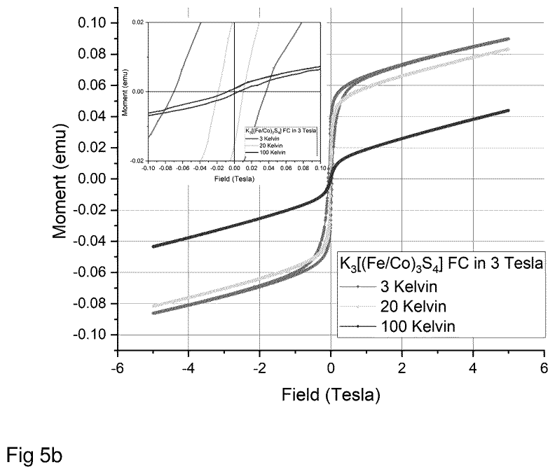

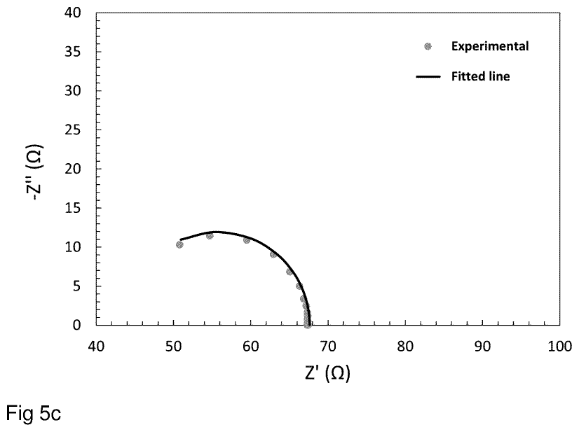

A detailed analysis of the field-magnetization curve at 3 K (not shown) indicates the asymmetric hysteresis loops including shifts in both the remanence, and the coercivity. Under applied fields the shifts are observed in opposite directions. The observed asymmetries are a well-known sign of exchange bias effects that horizontally and vertically shift the hysteresis loop. To investigate the induced (exchange bias) EB field more precisely, the FC hysteresis loops were measured at different temperatures after cooling under an applied field of 3 T (FIG. 5a). The field-dependent magnetization curves at 3 and 20 K demonstrate asymmetric half hysteresis loops in opposite directions of applied magnetic field, with the significant shifting for both remanence and coercivity values. FIG. 5b shows the variations of the EB field, which is equivalent to shifts in the coercivity, and the remanence as a function of increased temperature. By increasing the temperature beyond 100 K, both the EB field and the remanence are dramatically decreased to negligible values and approach a plateau at temperatures higher than 200 K. Such behavior is in good agreement with the calculated freezing temperature of spin glass phase based on the FC/ZFC curves.

At 3 K, the large EB field and the EB remanence are 35 mT and 0.27 Am² kg⁻¹, respectively (FIG. 5c). The disordered spin-glass moments can interact with antiferromagnetically ordered moments and pin them to induce the EB behavior. Indeed, the iron vacancies could play a mechanistic role to provide spontaneous EB effects by pinning the ordered magnetic areas. These findings could confirm the Fe vacancy effects on the recently introduced EB field in the AFM/spin-glass combined orderings.

### Ionic Conductivity

The dielectric properties of pellets of K₂[Fe₃S₄] sintered at 1103 K were measured at room temperature as a function of the alternating current, AC, with electrical field frequencies in the range of 100 Hz to 100 kHz. The real part (ε′) of the electrical permittivity can provide the dielectric constant k. The electrical permittivity was calculated according to the measured capacitance (C), surface of electrode plates (A), distance between electrode plates (d), and permittivity of vacuum (ε₀: 8.85×10⁻¹² m⁻³ kg⁻¹ s⁴A²) through equation 2.

$$ε = C d {ε}_{0}^{- 1} {A}^{- 1} \qquad ( 2 )$$

FIG. 6a (main frame) depicts the variations of the dielectric constant of K₂[Fe₃S₄] as a function of the frequency. Starting from low frequencies, the dielectric constant is rapidly reduced with an increase in the frequency due to the pining of charge domains and vanishing of the space charge polarization mechanism. Grain boundaries, disordering and displacements in the grains, vacancies, and other defects could significantly act as a pinning agent. At frequencies lower than 400 Hz, the measurement results were not reliable and thus omitted. In addition, there is an unexpected slight increase at frequencies between 400 to 800 Hz that might be caused by fringe effects. The average measured k at 1 kHz is 1119, that is comparable with barium titanate as a well-known commercial capacitor material, and higher than many other dielectric materials, such as strontium titanate, barium strontium titanate, and zirconate titanate.

The dielectric constant gradually reduces with an increase in the frequency; however, the rate of decrease is relatively low. Indeed, although the space charge polarization mechanism becomes ineffectual at high frequencies, the vacancies could still work as charge carriers and defects dipoles which are polarizable up to the MHz frequency range. FIG. 6b depicts the scanning electron microscopy micrograph in the backscattered electron mode from the cross-section surface of sintered pellets of K₂[Fe₃S₄], indicating the sintered grains and grain boundaries.

In addition, the complex impedance measurements were employed to investigate the electrical conductivity of K₂[Fe₃S₄]. Since the disordered areas including grain boundaries, and other structural defects could act as the efficient polarization areas, the Nyquist plot could be utilized to recognize these effects according to the equivalent circuit model including two parallel resistor-constant phase element series for ordered and disordered areas (FIG. 6c). The plot indicates two semicircular arcs with a small overlap, which can be assigned to ordered and disordered areas, respectively. This combination is in agreement with the model of grain—grain boundaries for solid-state electrolytes in Li/Na-ion batteries. Besides the semicircular arcs, there is a linear spike at low frequency range, which is related to the polarization of the electrode. This indicates an ionic contribution to the electrical conductivity.

K₂[Fe₃S₄] demonstrates very high ionic conductivity while the low ionic conductivity is the main drawback of the solid-state electrolytes in all solid-state batteries. The ionic conductivity and activation energy calculated by means of the Nyquist and Arrhenius equations yields 24.37 mScm⁻¹ and 0.089 eV, respectively. The calculated ionic conductivity for K₂[Fe₃S₄] is much higher than usual solid state electrodes and could be comparable with the common liquid electrolytes.

### Example 3: Analytics of Na₂[Fe₃S₄]

FIG. 2b (a) indicates the dielectric constants of the samples as a function of electrical field frequency in the range of 0.1 to 100 kHz. In all samples, the dielectric constant rapidly decreases with increasing frequency up to around 10 kHz, and then continuously decrease at a reduced rate. At frequencies lower than a critical range (approx. 1 to 10 kHz, depending on the materials and measurement conditions), the dominant polarization contribution is assumed to result from the space-charge mechanism which, in Na₂[Fe₃S₄], sharply vanishes at frequencies around 1 kHz. The dielectric constant of Na₂[Fe₃S₄]-923 (sintered at 923 K) is around 1850 at a frequency of 1 kHz, significantly higher than some benchmark dielectric materials such as barium and strontium titanates. Lower sintering temperatures result in lower dielectric constants.

Samples of Na₂[Fe₃S₄]-823 (sintered at 823 K) and Na₂[Fe₃S₄]-723 (sintered at 723 K) indicate dielectric constants of 1002 and 998 at 1 kHz, respectively. The dependency of dielectric constants to the sintering temperature can be explained by the considerable impacts of the sintering temperature on the bulk density of materials as a well-known phenomenon in electronic materials. At higher temperatures, a higher number of sintering mechanisms is activated, leading to potentially higher bulk density of materials. Lower sintering temperatures result in lower dielectric constants.

In a similar trend the dielectric losses of all samples are decreased for an increase of the measurement frequency, while the sample sintered at higher temperature shows lower loss values (FIG. 2b (a), inset frame). The dielectric losses of Na₂[Fe₃S₄]-923, Na₂[Fe₃S₄]-823, and Na₂[Fe₃S₄]-723 are around 0.045, 0.057, and 0.059, respectively, at 1 kHz.

Complex impedance measurements at ambient temperature were carried out to investigate the transport properties of the samples, by plotting the Nyquist curves of real and imaginary parts of the impedance. FIG. 2a (b) displays the Nyquist plots of samples sintered at different temperatures in the frequency range of 100 mHz to 1 MHz. Plots for all samples indicate a semicircular trend. The simulated curves were plotted by designing an equivalent circuit of two subsequent sections of parallel capacitor and resistor elements, with the sections representing the grain-grain boundary model on the complex impedance. The intersections of the curves with the Z axis were considered as the total bulk resistivity of the samples to calculate their ionic conductivity. The value of bulk resistivity is decreased by increasing the sintering temperature, from approx. 1955Ω for the sample of Na₂[Fe₃S₄]-723, to 932Ω for Na₂[Fe₃S₄]-823, and to 647) for Na₂[Fe₃S₄]-923. As the sintering at higher temperature principally results in a higher density of the bulk material, the potential porosities within the samples sintered at lower temperatures can act as non-conductive barriers for the ion transfer through the microstructure. The calculated ionic conductivity of the sample of Na₂[Fe₃S₄]-923 is 3.37 ms·cm⁻¹ which is in the range of highest reported values for sodium ionic conductivity.

### Example 4: Analytics of K₂[Co₃S₄]

The conducted magnetometry measurements of K₂[Co₃S₄] at different temperatures, including field-dependent magnetization curves and temperature-scan curves, are presented in FIG. 3b. The magnetization curves as a function of external applied field up to 4.00 T (FIG. 3b (a)) indicate the hysteresis curves at low temperatures of 3, 20, and 100 K, while the by increasing the temperature the curves change to the narrower loops, decreasing the coercivity and remanent magnetization values. At these temperatures, the plots show a linear trend upon the applied field of higher than 0.35 T, which could consider as a minor sign of AFM structure. At the temperature of 300 K, the curve shows a fully linear trend of magnetization plot, as evidence of the paramagnetic structure. To reveal the main magnetic ordering of the structure, the susceptibility measurements were carried out. The inverse of magnetic susceptibility curve versus temperature, is displayed in FIG. 3b(b), indicating a deviation from the fitting line of the Curie-Weiss law. The negative value of Curie-Weiss constant of around −780 K is evidence of the AFM structure of K₂[Co₃S₄]. The high absolute value of Curie-Weiss constant proves the strong AFM interaction in the structure. The calculated effective moment is around 20 μB. The utilized equation and calculation details of effective moment are presented in the SI. The deviation point shows a Néel temperature of around 200 K, as a transition temperature to the paramagnetic behavior of K₂[Co₃S₄], which agrees with the linear paramagnetic curve at 300 K, in the field-dependent measurements (FIG. 3b(a)). The temperature-dependent magnetization curves consisting of the FC and ZFC measurements' results are illustrated in FIG. 3b (c). ZFC and FC curves indicate four transition points including the Néel temperature at 200 K, the irreversible bifurcation temperature (T_{Irr}) at around 65 K, and two anomalies at around 35 and 105 K, which are abbreviated as T₁ and T₂, respectively. At the temperatures lower than T_{Irr}, the magnetization is increased because of the occurred spin canting in the AFM structure. In addition, at low temperatures, the hysteresis loops (FIG. 3b(a)) display the shifting deviation from the zero point which is considered as a sign of exchange bias (EB) effect. EB effect is a magnetic interfacial phenomenon, theoretically raised from the combination of two different magnetic orders, most commonly ferromagnetic and antiferromagnetic structures.

FIG. 3c(a) displays the results of dielectric measurements, at room temperature, of the samples sintered at three different temperatures of 903, 1003, and 1103 K which are abbreviated as samples K₂[Co₃S₄]-903, K₂[Co₃S₄]-1103, and K₂[Co₃S₄]-1103, respectively. At 1 kHz, as an accepted standard frequency for the applications, the dielectric constants (K) of K₂[Co₃S₄]-903, K₂[Co₃S₄]-1003, and K₂[Co₃S₄]-1103 are around 550, 1220, and 2650, respectively. The values, particularly the latest one, are significantly higher than benchmark dielectric materials for the applications as the circuit capacitors such as barium and strontium titanates (=1000 to 2000) as well as high-K dielectric gate standard material (SiO₂, =3.9) for the MOSFET applications. The enhanced values of dielectric constants as a function of sintering temperature can be explained by higher density as well as larger domain to domain boundary ratio which potentially create larger space charge polarization areas. For all samples, by increasing the frequency the dielectric constant values decreased, sharply in the initial step from 0.1 to 2 kHz, and then gradually in the range of 4 to 100 kHz. As a well-stablished phenomenon, the sharp decreasing is attributed to the vanishing of space charge polarization mechanisms at high frequencies, while it is dominant mechanism at frequencies lower than 10 kHz. In parallel, the dielectric loss values of all samples are decreased by increasing the frequency. At frequency of 1 kHz, for all samples these values are lower than 0.1, as a well-defined criterion of dielectric loss for the capacitor and MOSFET applications, indicating the reliability of the measurements. In addition, the increase in sintering temperature leads to slightly decrease the loss values due to the higher density of samples sintered at higher temperatures.

The Nyquist plots of conducted impedance measurements, at room temperature, of the samples sintered at different temperatures as well as the simulated complex impedance plots are shown in FIG. 3c(b). All samples present the semi-circular arcs with the intercept points with the real impedance (Z) axis of around 161Ω for K₂[Co₃S₄]-903, 153Ω for K₂[Co₃S₄]-1003, and 81Ω for K₂[Co₃S₄]-1103. The corresponding ionic conductivity values calculated based on the Nyquist equation²¹ are 9.4, 11.1, and 21.3 ms·cm⁻¹ for the samples of K₂[Co₃S₄]-903, K₂[Co₃S₄]-1003, and K₂[Co₃S₄]-1103, respectively.

### Example 5: Analytics of K₂[Fe₃Se₄]

The field dependent magnetization (M-H) curves at different temperatures are shown in FIG. 4b. According to these results, the general ordering of K₂[Fe₃Se₄] is antiferromagnetic, while the tiny hysteresis loops at the curves, especially at the low temperatures could be considered as a magnetic disordering such as ferro-/ferri-magnetic phase or spin glass phase.

The applied field was up to 5.00 T. After field cooling, the applied field was up to 3.00 T. At all temperatures, the trend of hysteresis behavior is visible. The magnetization values seem temperature dependent, with increasing temperature values the magnetization decreases.

The curves of low temperatures of 2 and 20 K (not shown) show a strong sign of exchange bias effects, indicating large exchange bias fields of around 0.22 T at 2 K and 0.13 T at 20 K. The results of magnetic measurements and the observed exchange bias effects are in agreement with the obtained results for the isotypic structures and sulfido ferrate and cobaltate. The origin of these effects could be explained by the combination of antiferromagnetic ordering of the compound and potential spin glass areas.

A decrease of dielectric constant with increasing frequency is determined. At 1 kHz at 293 K, a k-value of 2029 is determined (FIG. 4c (a)). Nyquist plot of complex impedance measurements of K₂[Fe₃Se₄] is presented in FIG. 4c(b). The complex impedance curve is semicircular with the intercept of 75.56Ω with the real impedance axis, which is considered as a bulk resistance of the sample. The calculated value of ionic conductivity based on the Nyquist equation indicate a very high value of 31.04 ms·cm⁻¹ at room temperature. This finding is in agreement with the obtained ionic conductivity values for the isotypic structures of sulfido ferrate and cobaltate.

### Example 6: Analytics of K₂[(Fe/Co)₃Se₄]

Central metal deficiency in quantum materials has remarkable impacts on magnetic and electrical properties, introducing novel candidates for related applications such as energy storage devices and spintronic systems. In this work, we introduced a novel quaternary compound of potassium sulfido ferro-cobaltate of K₂[Fe_{1.5}Co_{1.5}S₄]. The central metal positions in anionic moiety are shared by iron and cobalt ions, equally, while they statistically occupied 75% of these positions, indicating 25% of central metal vacancies in the layered anionic sublattice. The impedance and dielectric investigations indicate remarkable ionic conductivity of 23.1 ms·cm⁻¹, which is between the reported values for ternary potassium sulfido-cobaltate and ferrate. The obtained value is in the range of highest ever reported values for potassium-containing bulk materials. Magnetometry results illustrate the antiferromagnetic structure with an intrinsic exchange bias field of 28 mT at 2 K. The observed exchange bias field could be potentially attributed to the interfacial effects of interaction between antiferromagnetic order and distributed disordering areas in the magnetic structure of the compound.

1. An alkali metal metalate compound with magnetic exchange bias and ionic conductivity properties having the general formulae (I)
$${A}_{2} [ {{M}^{1}}_{3 - x} {{M}^{2}}_{x} {Z}_{4} ] \qquad ( I )$$
with
A being one of Li, Na, K,
M¹, M² being one or more of Cr, Mn, Fe, Co, Ni, Cu, Zn,
Z being S or Se,
x being 0-3, preferably 0, 0.01, 0.1, 0.5, 1, 1.5, 2, 3,
whereby the compounds K₂[Ni₃S₄], K₂[Zn₃S₄], K₂[Mn₃S₄], Na₂[Mn₃Se₄], and K₂[Ni₃Se₄] are exempted.

2. The compound according to claim 1, having the general formulae (II)
$${A}_{2} [ {{M}^{1}}_{3 - x} {{M}^{2}}_{x} {Z}_{4} ] \qquad ( II )$$
with
A being Na or K,
M¹ being Fe;
M² being one or more of Cr, Mn, Co, Ni, Cu, Zn,
Z being S or Se,
x being 0-3, preferably 0, 0.01, 0.1, 0.5, 1, 1.5, 2, 3.

3. The compound according to claim 1, having the general formulae (III)
$${A}_{2} [ {Fe}_{3 - x} {{M}^{2}}_{x} {Z}_{4} ] \qquad ( III )$$
with
A being Na or K,
M² being one or more of Cr, Mn, Co, Ni, Cu, Zn,
Z being S or Se,
x being 0, 0.01, 0.1, 0.5, 1, 1.5, 2, 3.

4. The compound according to claim 1, wherein, the compound is one of the following:
A₂[Fe₃S₄];
A₂[Fe₂CoS₄]; A₂[Fe_{1.5}Co_{1.5}S₄]; A₂[FeCo₂S₄]; A₂[Co₃S₄];
A₂[Fe₂NiS₄]; A₂[Fe_{1.5}Ni_{1.5}S₄]; A₂[FeNi₂S₄]; A₂[Ni₃S₄];
A₂[Fe₂CuS₄]; A₂[Fe_{1.5}Cu_{1.5}S₄]; A₂[FeCu₂S₄]; A₂[Cu₃S₄];
A₂[Fe₂ZnS₄]; A₂[Fe_{1.5}Zn_{1.5}S₄]; A₂[FeZn₂S₄]; A₂[Zn₃S₄];
A₂[Fe₂MnS₄]; A₂[Fe_{1.5}Mn_{1.5}S₄]; A₂[FeMn₂S₄]; A₂[Mn₃S₄];
A₂[Fe₂CrS₄]; A₂[Fe_{1.5}Cr_{1.5}S₄]; A₂[FeCr₂S₄]; A₂[Cr₃S₄];
A₂[Fe₃Se₄];
with A being Na or K.

5. The compound according to claim 1, wherein the compound is one of the following:
K₂[Fe₃S₄]; Na₂[Fe₃S₄];
K₂[Fe₂CoS₄]; K₂[Fe_{1.5}Co_{1.5}S₄];
K₂[Co₃S₄];
K₂[Cr₃S₄];
K₂[Fe₃Se_{4].}

6. The compound according to claim 1, having an ionic conductivity in a range between 1×10⁻¹ and 1×10⁻³ Scm⁻¹, preferably in a range between 1×10⁻² and 1×10⁻³ Scm⁻¹, more preferably between 2×10⁻² and 8×10⁻² Scm⁻¹.

7. The compound according to claim 1, having an exchange bias field in a range between 20 and 50 mT, preferably between 30 and 40 mT, more preferably between 33 and 38 mT at 3K.

8. A method for obtaining a compound according to claim 1, comprising the step of reacting A₂Z with equivalents of M¹Z and M²Z at a temperature between 1073 K and 1473 K, preferably between 1123 K and 1373 K, more preferably between 1173 K and 1273 K, under inert gas atmosphere for 5-30 min, preferably 10-20 min.

9. The method according to claim 8, wherein A₂Z is obtained from reacting elemental A and elemental Z in liquid NH₃ under inert gas atmosphere.

10. (canceled)

11. (canceled)

12. Compound according to claim 1, applicable for exchange bias applications, in particular in transistors, MOSFETs, MRAMs, or as solid-state electrolytes, in particular in solid-state electrolytes, in particular in alkali-metal batteries.
